(19) United States
(12) Patent Application Publication
(10) Pub. No.: US 2016/0143346 A1
(43) Pub. Date: May 26, 2016

(54) Fiber separation from grains and grain products using electrostatic methods

(71) Applicants: Tejas S. Pandya, Oxford, MS (US); Radhakrishnan Srinivasan, Starkville, MS (US)

(72) Inventors: Tejas S. Pandya, Oxford, MS (US); Radhakrishnan Srinivasan, Starkville, MS (US)

(73) Assignee: Mississipi State University, Mississippi State, MS (US)

(21) Appl. No.: 14/544,130

(22) Filed: Nov. 26, 2014

(51) Int. Cl. A23P 1/12

(52) U.S. Cl. CPC A23P 1/12

(57) ABSTRACT

The methods, system, and apparatus of the invention provide processes using electrostatic methods for separating fiber from grains and grain products into fiber-enriched grain material fractions and enriched fiber-reduced grain material fractions.

### CROSS-REFERENCE TO RELATED APPLICATION

This application claims priority from U.S. Provisional Patent Application Ser. No. 61/963,247 filed Nov. 27, 2013. The entirety of that provisional application is incorporated herein by reference.

### STATEMENT OF GOVERNMENT SUPPORT

This invention was made with government support under grant 0212821 awarded by the National Institute of Food and Agriculture, USDA. The government may have certain rights in the invention.

### FIELD OF THE INVENTION

The present invention relates to the separation of fiber from grain and grain products. More specifically, the invention provides novel methodologies for fiber separation from grains and grain products using electrostatic methods that result in useful fiber-enriched grain materials and fiber-reduced grain materials.

### BACKGROUND OF THE INVENTION

Fiber-enriched grain products or materials and enhanced fiber-reduced grain products or materials, enhanced in fat content, protein content, or both, are valuable products for ethanol production and animal feed production, respectively. A method of removing fiber from grain products using a combination of sieving and air classification has been developed for distillers dried grains (DDG) and distillers dried grains with solubles (DDGS) material in U.S. Pat. No. 7,670,633. A method of fiber separation from grain materials such as corn flour, soybean meal, cottonseed meal, and wheat middlings, was developed using the Elusieve process. This process is composed of combining sieving and air classification (elutriation) using grain particle size and size, shape, weight, or density, respectively, or combinations thereof, for separation, in U.S. Pat. No. 8,518,467. The present invention uses electrostatic separation of fiber from grains and grain products and further encompasses using the electrostatic method in conjunction with separation by sieving and/or air classification, such that any one method can be used individually or in any combination, and in any order in time, for separating fiber-rich and fiber depleted material. The electrostatic method of the invention can be repeatedly utilized on the previous fiber-enriched grain material, as well as repeated use of the other separation methods in combination or individually, until no appreciable fiber-enriched material is obtainable.

The present invention provides novel methods for the separation of fiber from grain and grain products utilizing variable and controllable electrostatic fields or charges to separate the fiber-enriched grain materials from the fiber-reduced grain materials. The fiber-enriched materials or particles are attracted to at least one oppositely charged source, thereby efficiently separating the fiber-enriched grain materials from the fiber-reduced grain materials. Repeating the separation process as many times as necessary using the electrostatic methods, and/or the sieving and air classification methods individually or in combination, further separates the fiber-enriched and fiber-reduced grain materials.

### SUMMARY OF THE INVENTION

Separation of fiber from grain and grain products is important in that at least two valuable products result therefrom—namely, fiber-enriched grain products or materials and enhanced fiber-reduced grain products or materials, both of which are useful for many purposes. The present invention provides methods for producing such fiber-enriched materials and enhanced fiber-reduced materials from grains and grain products using electrostatic methods. Additionally, the invention encompasses using the novel electrostatic methods in conjunction with sieving and air classification (elutriation), the combination being known as the Elusieve process, which are two methods of separating fiber from grains and grain products that use particle size, shape, weight, or density, or combinations thereof, for separation. The invention also discloses that any of these separation methodologies can be used in any combination in any order and repeated individually or in combination to further separate fiber from grain material, as many times as necessary to ensure effective separation.

With the foregoing and other objects, features, and advantages of the present invention that will become apparent hereinafter, the nature of the invention may be more clearly understood by reference to the following detailed description of the preferred embodiments of the invention and to the appended claims.

### BRIEF DESCRIPTION OF THE DRAWINGS

These drawings accompany the detailed description of the invention and are intended to illustrate further the invention and its advantages:

FIG. 1 depicts a schematic illustration of the experimental design for hammer milling of corn, or other grains, and processing and separating of fiber-enriched grain materials or particles from non-fiber or fiber-reduced grain materials or particles by the electrostatic method of separation of the invention.

FIG. 2 depicts a schematic illustration of the experimental design of fiber separation from grain material by electrostatic separation, sieving, and air classification.

FIG. 3 depicts a graphical illustration of the percent of high fiber content neutral detergent fiber (NDF) in electrically lifted fractions of original corn flour; large, medium, and small corn fractions; and large, medium, and small lighter fractions (LF) from the Elusieve process (dry basis) versus electrostatic current in microamperes.

### DETAILED DESCRIPTION OF THE INVENTION

### Background

Fiber present in corn and distillers dried grains with solubles (DDGS) is not digested well by non-ruminant animals such as chicken and swine. DDGS consists of non-fermentable components of the original grain, such as protein, lipids, and fiber. Also, this fiber does not participate in the conversion of starch to ethanol. Enhancement of corn results in high starch animal feed and, when used for the production of fuel ethanol, enhanced corn flour results in increased ethanol productivity. Enhancement of DDGS likewise results in high protein feed. The fiber separated can be used as a feedstock for the production of valuable products like cellulosic ethanol, corn fiber gum, and polymer composites. The present invention comprises a novel method of electrostatic separation of fiber from starting material grain products including, but not limited to, corn flour and DDGS, as well as grain, oilseed, grain product, oilseed product, corn, distillers dried grains (DDG), sorghum, barley, soybean, cottonseed, oats, rice, rye, or a combination thereof.

### INTRODUCTION

In the United States, corn is widely used as food and feed as well as for ethanol production. Corn kernels contain about 9% fiber by weight, which comprises mainly cellulose and hemicellulose. Fiber is not digested well by non-ruminants such as chicken and swine. Also, fiber is non-reactive in the dry grind process for the production of ethanol. Separation of fiber can enhance starch in animal diet and increase starch loading in ethanol plant. A recent broiler nutrition study showed that the body weight of chicks (21 day study) increased, feed conversion ratio improved, and diet cost was slightly higher when fed a reduced fiber corn diet (Srinivasan and Corzo, 2011). An unpublished work conducted by the authors of this study found favorable economics for increasing ethanol output (by about 4.4%) due to higher starch loading by removal of fiber from ground corn flour prior to fermentation.

The Elusieve process, a combination of sieving and air classification (elutriation), has been developed to separate fiber from ground corn flour (Pandya et al, 2012; Srinivasan et al, 2008). Milled corn flour is fractionated size wise and air is blown through individual size fractions, which results in lighter fractions with higher fiber content and heavier fractions with higher starch content. Separated fiber can be used as a feed for ruminants such as cattle and for production of products such as corn fiber gum, oligosaccharides, phytosterols, and polyols (Doner et al. 1998, Crittenden and Playne 1996; Moreau et al. 1996; Buhner and Agblevor 2004). While conducting research on corn fiber separation using the Elusieve process, it was observed that corn fiber had a tendency to stick to plastic bags and buckets used for storing these samples. Based on this tendency of fiber particles to stick to the plastic containers, the inventors evaluated electrostatic methods to separate fiber from milled corn flour, resulting in the present invention.

In an embodiment, the present invention provides a method of obtaining a fiber-enriched grain material or fraction and an enhanced fiber-reduced grain material or fraction from starting grain material by using electrostatic separation of the fiber-enriched material from the enhanced fiber-reduced material. The fiber-reduced material possesses enhancements including, but not limited to, increased starch, fat, and/or protein or a combination thereof. Each fiber-enriched material has higher fiber content relative to the previous grain material, or fiber-enriched material, prior to being electrostatically separated; similarly, each enhanced fiber-reduced grain material is improved with additional enhancements relative to the previous grain material or fiber-reduced material prior to being electrostatically separated. The process can be repeated as many times as necessary using subsequent fiber-enriched grain material or fractions and/or enhanced fiber-reduced grain material or fractions to ensure effective separation.

In another embodiment, the invention provides a method of obtaining a fiber-enriched grain material or fraction and an enhanced fiber-reduced grain material or fraction containing increased starch, fat, and/or protein or a combination thereof, for example, from starting grain material by using electrostatic separation and sieving separation of the material based on particle size. Each respective product of the two processes has increased fiber content and reduced fiber content, respectively. The processes can be repeated as many times as necessary individually or in combination using subsequent fiber-enriched grain material or fractions and/or enhanced fiber-reduced grain material or fractions to ensure effective separation. Moreover, the processes can be completed in any order to optimize the fiber separation results.

In a further embodiment, the invention provides a method of obtaining a fiber-enriched grain material or fraction and an enhanced fiber-reduced grain material or fraction containing increased starch, fat, and/or protein or a combination thereof, for example, from starting grain material by using electrostatic separation and using air classification separation of the material based on particle size, shape, weight, density, or a combination thereof. Each respective product of the two processes has increased fiber content and reduced fiber content, respectively. The processes can be repeated as many times as necessary individually or in combination using subsequent fiber-enriched grain material or fractions and/or enhanced fiber-reduced grain material or fractions to ensure effective separation. Additionally, the processes can be completed in any order to optimize the separation results.

In yet a further embodiment, the invention provides a method of obtaining a fiber-enriched grain material or fraction and an enhanced fiber-reduced grain material or fraction containing increased starch, fat, and/or protein or a combination thereof, for example, from starting grain material by using electrostatic separation, using sieving separation based on particle size, and using air classification separation of the material based on particle size, shape, weight, density, or a combination thereof. Each respective product of the three processes has increased fiber content and reduced fiber content, respectively. The processes can be repeated as many times as necessary individually or in combination using subsequent fiber-enriched grain material or fractions and/or enhanced fiber-reduced grain material or fractions to ensure effective separation. Moreover, the processes can be completed in any order to optimize the separation results.

In yet another embodiment, the invention provides a method of obtaining a fiber-enriched grain material or fraction and an enhanced fiber-reduced grain material or fraction containing increased starch, fat, and/or protein or a combination thereof, for example, from starting grain material by using electrostatic separation, wherein an electrostatic field or charge is applied to the starting grain material (or fraction) and is generated by application of an external electric field without an electrostatically-charged device or surface, by mechanical contact to create an opposing and thereby attracting static electric field or charge between the fiber-enriched grain material (or fraction) and another material, by contact between the fiber-enriched grain material (or fraction) and a material disposed to creating a static electric field or charge therebetween, or a combination thereof. These processes can be repeated as many times as necessary individually or in combination using subsequent fiber-enriched grain material or fractions and/or enhanced fiber-reduced grain material or fractions to ensure effective separation results. The processes can be completed in any order with sieving, air classification, or both, to optimize the separation results.

Each embodiment described herein results in separated material that is enriched in fiber and reduced in fiber, respectively, relative to the starting grain material and to the immediately preceding separated fiber-enriched and fiber-reduced material (or fraction) and wherein the enhanced fiber-reduced material (or fraction) is enriched with increased starch content, fat content, protein content, or a combination thereof, relative to the starting grain material and to the immediately preceding separated enhanced fiber-reduced material (or fraction).

Electrostatic separation works on the principle of unlike charges attracting each other. For the present invention, electrostatic separation is used to separate particles from granular mixtures under the influence of electrical forces which impart charge to the particles. The combination of sieving and air classification separates fiber particles and nonfiber particles by taking advantage of the differences in physical properties such as size, shape, and density. Differences in dielectric properties could also be utilized by the electrostatic method and thus improve separation efficiencies. Electrostatic properties of wheat bran and its constitutive layers have been studied to separate nutrients from undesirable components of the bran (Hemery et al., 2009). Electrostatic separators have been studied for seed cleaning (Harmond et al., 1961). The principles of electrostatics have been applied for sorting out seeds, cleaning, and upgrading seeds (Kenneth, 1967).

No previous work has evaluated the electrostatics method for fiber separation from corn. The aim of the study that resulted in the present invention was to evaluate the effectiveness of electrostatic separation of fiber particles from original corn flour, from size fractions of corn flour, and from fractions obtained from sieving and air classification of ground corn flour. The methods, system, and apparatus of the present invention resulted from that study. The electrostatic separation methods of the invention for separating fiber from grain and grain products can be applied to other grains and grain products and materials.

### Conception

While working with corn flour, DDGS, and sorghum flour, it was observed that the fiber particles present in the same tend to stick to the containers used to handle these flours, i.e., plastic buckets, plastic scoops, and plastic bags. The fiber particles' affinity towards the plastic containers is due to the difference in electrical properties of fiber and nonfiber particles. Hence, having observed this behavior of fiber particles, the inventors further explored the principles of electrostatics for effective separation of fiber and nonfiber particles and the result was the present invention using novel electrostatic separation methods.

### Materials and Methods

### Hammer Milling of Corn Kernels

The milling of corn kernels was carried out using the procedure described by Pandya et al., (2012), as one of many possible methods for preparing, drying, milling, and/or grinding was possible. An air-assisted hammer mill (Model E-1906, Bliss Industries, Okla.) was used to mill yellow dent corn procured in 50 lb bags from a local farmers' co-operative store (Starkville, Miss.). A hopper with slide-gate was mounted on the hammer-mill inlet. The slide-gate was opened approximately twice every minute to gravity-feed the corn kernels into the crushing chamber. The milling was accomplished when corn was crushed by hammers rotating inside the chamber. When particles were small enough to pass through the retention screen, they exited the hammer mill. Pneumatic suction, at the hammer mill outlet, by a fan mounted on a cyclone facilitated the discharge of milled material. Pandya et al. (2012) found that a 3.2 mm ( 8/64″) retainer screen resulted in the best quality fiber separation. Thus, in this study, corn was hammer milled using the 3.2 mm retainer screen size.

### Electrostatic Separation

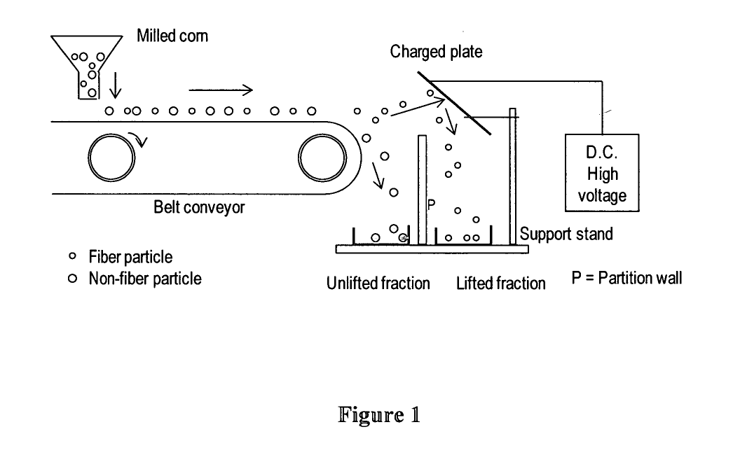

An apparatus and system was built to fractionate material using an externally-applied electric field (FIG. 1). FIG. 1 shows a schematic illustration of the experimental design for hammer milling of corn, or other grains or grain materials, and processing and separating of fiber-enriched grain materials or particles from non-fiber or fiber-reduced grain materials or particles by the electrostatic method of separation of the invention. The system consists of at least one high voltage, low current direct current (DC) electrical source with an adjustable current range of from 0 to about 35 μA (Model# HV350-Negative charge, Information Unlimited, Amherst, N.H.), at least one (for the experimental setup, approximately 10″×12″ metal) conducting plate, device, material or surface to create or to provide a charged field, and a conveyor belt or similar means to carry or to transport material to be fractionated. Plate or conducting surface size is adjustable depending on multiple factors, such as the amount of material to be separated. The DC source is variable, adjustable, and controllable and is electrically connected to the conducting surface, supported by a stand or similar support system. A partition wall or dividing means is used to ensure lifted and unlifted fraction streams stay segregated.

In the design, about one kg of material was spread as a thin layer at the bottom of the conveyor belt. To ensure consistency of separation, the conveyor belt speed, angle of tilt (45 degrees) of belt, and the distance of the charged metal (steel) conducting plate from the tip of the conveyor belt were kept constant. As the material on the conveyor belt approached the charged metal plate, it was influenced by the electric field. The negatively-charged plate attracted positively-charged particles (mainly fiber particles). The material attracted by the metal plate was the “lifted” fraction and the other stream of material that failed to get lifted off the surface of the conveyor belt was the “unlifted” fraction. The charged fiber-enriched grain material was attracted to the opposite charge of the source and charged surface or material. The unlifted material or fraction coming off the conveyor belt was collected in a bin and re-fed two more times to ensure separation. The initial current to electrostatically charge the plate was set such that about 4 to 5 wt % of material was lifted by the charged field. The study was conducted at incremental current values to evaluate the quality of separation under varying strengths of electrostatic field.

### Experiment Scheme

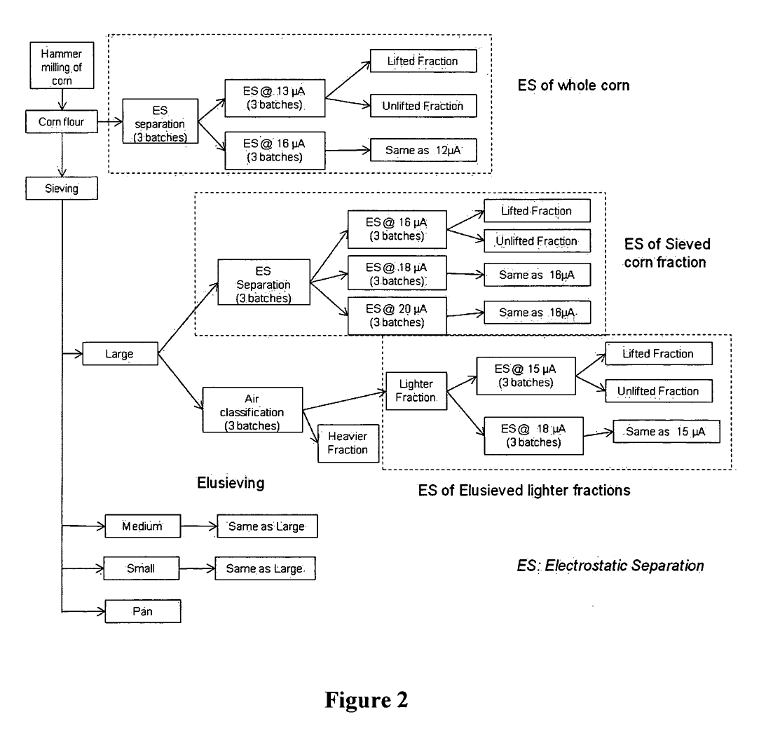

The study that resulted in the present invention was designed to evaluate the electrostatic method for fiber separation from corn flour and to compare the fiber and enhanced flour products from four different corn flour treatments (FIG. 2). FIG. 2 shows a schematic illustration of the experimental design of fiber separation from grain material by electrostatic separation, sieving, and air classification. However, starting grain material can be many materials including grain, oilseed, grain product, oilseed product, corn, distillers dried grains (DDG), distillers dried grains with solubles (DDGS), sorghum, barley, soybean, cottonseed, oats, rice, rye, or a combination thereof. Nearly 100 kg of milled corn flour was divided into four units. Each unit of 25 kg corn flour was used for conducting a treatment. The first treatment was electrostatic fractionation of the original corn flour. The second treatment was the electrostatic fractionation of sieved corn fractions. Milled corn flour was sieved into four size fractions: large, medium, small, and pan, with pan being the finest of these fractions. The selection of sieve sizes was similar to the procedure described by Pandya et al. (2012). Each batch of material was sieved using a vibratory sifter (Model ZS30-S6666, SWECO Vibro-Energy Separator, Florence, Ky.) using three screens, one screen at a time. The corn hammer milled using a 3.2 mm retention screen was sieved using 12M (1,532 μm), 16M (1,130 μm), and 24M (704 μm), which resulted in 44.1% large, 22.6% medium, 12.5% small, and 20.8% pan size fractions by weight. The electrostatic method was applied on large, medium, and small size fractions.

The third treatment was fiber separation using the Elusieve process, where size fractions were air classified. In air classification, the material carried by air is called the ‘lighter’ fraction and the material that is not carried by air is called the “heavier” fraction. The fiber product comprised lighter fractions resulting from air classification. Enhanced flour product comprised heavier fractions from air classification and the pan size fraction. There was no electrostatic separation in the third treatment. The fourth treatment was electrostatic fractionation or separation of the lighter fractions from the Elusieve process.

Samples were collected from each fraction for composition analyses. For the first treatment, samples were collected from the original corn flour, lifted and unlifted fractions for about 13 to about 16 μA current values (FIG. 2). For the second treatment, the samples were collected for large, medium, small, and pan size fractions, and lifted and unlifted fractions at currents in the range of about 13 to about 20 μA. For the third treatment, 10 kg each of large, medium, and small corn flour fractions were subjected to air classification. The samples were collected for lighter and heavier fractions of large, medium, and small size fractions. In the fourth treatment, lighter fraction material from the third treatment was subjected to electrostatic fractionation or separation. Lighter fractions which were subjected to electrostatic fields resulted in lifted and unlifted fractions. The samples were collected for lifted and unlifted fractions in the current range of about 15 to about 20 μA. Processing was carried out in three batches for each of the above cases, resulting in a total of 136 samples.

For each of the above four treatments, two products were evaluated for comparison, a fiber product that had high fiber content (NDF), and an enhanced flour product that had lower fiber content. The fiber product was calculated from the composition of lifted fractions for treatments that used electrostatic separation, and from air classified lighter fractions in the case of Elusieve products. In the fourth treatment where the electrostatic method was used in conjunction with the Elusieve process, the fiber product comprised lighter fraction from large size, lighter fraction from medium size and lifted fraction from small sized lighter fraction. The enhanced flour product was calculated by material balance, by subtracting fiber composition from original corn flour. Thus, four sets of fiber and enhanced flour products were compared: 1) electrostatic fractionation or separation of original corn flour, 2) electrostatic fractionation or separation of sieved flour fractions, 3) Elusieve processing, and 4) electrostatic fractionation or separation of corn flour fractions separated by the Elusieve process.

### Sample Analyses

Compositions were obtained as the mean of three batches. The samples were ground to a fine powder using a coffee grinder prior to analysis to avoid particle segregation. Analyses of samples were carried out at a commercial laboratory (Midwest Labs, Omaha, Nebr.). Neutral detergent fiber (NDF) content was determined using the procedure of Van Soest et al. (1991). Moisture content was determined using the two-stage convection oven method (AACC International 2000, Method 44-18). Compositional results for fractions were reported and discussed in dry basis, while compositional results for the products were reported and discussed in wet basis.

### Statistical Analyses

Analysis of variance (ANOVA) and Duncan's test (SAS Institute, Cary, N.C.) were used to compare means of compositions of samples from three batches. Statistical significance level was 5% (p<0.05).

### Results and Discussion

### Effect of Current on Fiber Separation

In all cases, lifted fractions had a higher fiber content than corresponding unlifted fractions and the starting material, which showed that the fiber was preferentially attracted by the electrostatically-charged conducting plate or surface. Unlifted fractions had lower fiber content than corresponding starting material. For example, at 18 μA, lifted fraction from large size fraction had NDF of 48.9%, which was higher than the NDF of unlifted fraction (4.6%) and NDF of large size fraction (6.9%).

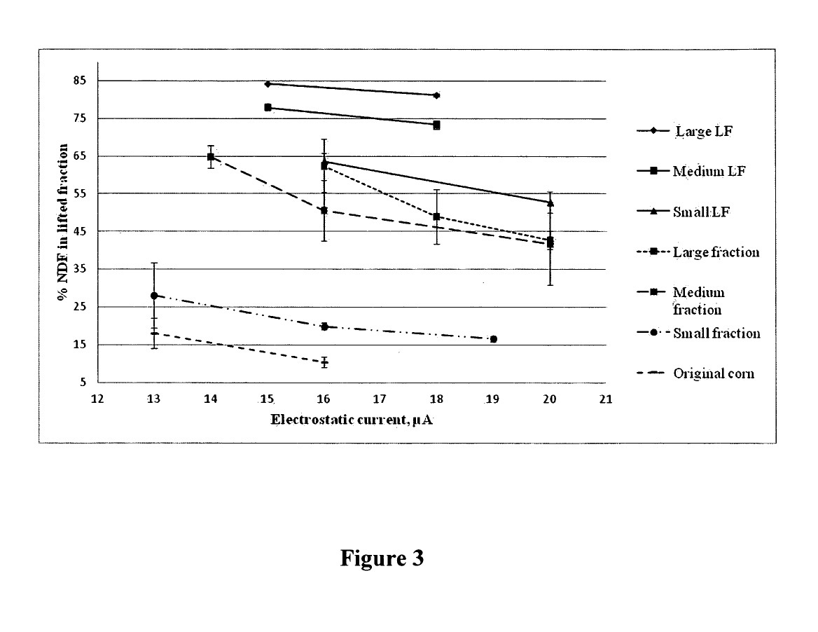

In all the treatments, it was observed that the NDF content of the lifted fraction decreased as current was increased (Table 1, FIG. 3). FIG. 3 shows a graphical illustration of the percent of high fiber content neutral detergent fiber (NDF) in electrically lifted fractions of original corn flour; large, medium, and small corn fractions; and large, medium, and small lighter fractions (LF) from the Elusieve process (dry basis) versus electrostatic current in microamperes using the electrostatic separation method of the present invention. For the original corn flour, as current was increased from about 13 to about 16 μA, the yield of lifted fraction increased from 3.1 to 3.9% and the NDF content decreased from 18.1 to 10.4%. For medium size fraction, as current increased from about 14 to about 20 μA, yield of lifted fraction increased from 4.2% to 10.5% and the NDF content of lifted fraction decreased from 64.8% to 41.7% (Table 1, FIG. 3).

### Effect of Sieving on Electrostatic Separation

NDF contents of large, medium, small, and pan size fractions were 6.9, 11.3, 10.3, and 8.6%, respectively (Table 1). For large size fraction (>1,532 μm), the best lifted fraction had an NDF content of 62.4% at 4.1% yield. The NDF content in best lifted fractions from the size fractions were comparable to the NDF of lighter fractions from Elusieve processing. The NDF of lighter fractions from large, medium, and small size were 64.0, 46.2, and 22.1%, respectively, which were comparable to the NDF of best lifted fractions that had an NDF of 62.4, 64.8, and 28.1%, respectively. The results showed that lighter fraction from medium size had lower NDF (46.2%) compared to an NDF of 77.6% in earlier experimental work because the lighter fraction yield of 12.2% used in this study was higher than that in earlier experimental work (8.3%) (Pandya et al. 2012).

### Effect of Sieving and Air Classification on Electrostatic Separation

Air classification of large, medium, and small sieved fractions resulted in lighter fractions with yield ranging from 4.7 to 16.0% by weight, and NDF content of 62.4, 64.8, and 28.1% respectively. The NDF content of lifted fractions from lighter fractions was found to be 84.3, 77.9, and 63.7% for large, medium, and small sizes, respectively. The electrostatic methods of the present invention resulted in high quality fiber.

### Products

For original corn flour, electrostatic fractionation or separation resulted in a fiber product yield of 3.1% that had an NDF of 16.5% at the best separation condition (Table 2). Thus, the electrostatic method alone was not as effective as the Elusieve process when applied alone directly on original corn flour. The Elusieve process resulted in a fiber product with an NDF of 40.5% at a yield of 6.6%. (Table 2).

Electrostatic fractionation or separation of sieved fractions resulted in a fiber product with 3.2% yield and 54.2% NDF content (Table 2). Although the fiber product from electrostatic fractionation or separation of size fractions had higher NDF content (54.2%) than fiber product from Elusieve processing (NDF of 40.5%), the yield of fiber product (3.2%) was lower than the yield of fiber product from Elusieve processing (6.8% yield). In earlier experimental work, the inventors obtained fiber product with NDF of 57.6% at 3.1% yield, which is similar to that obtained by electrostatic fractionation or separation of size fractions (NDF of 54.2% at 3.2% yield) (Pandya et al. 2012). Thus, the electrostatic methods of the invention have the potential to take the place of the air classification step of Elusieve processing without any change in fiber separation effectiveness. Operating and capital costs of each method would be determining factors in choosing between electrostatic fractionation and air classification, after or in conjunction with sieving processing.

Although electrostatic fractionation or separation of the Elusieve process's large and medium lighter fractions results in high fiber contents in lifted fractions (NDF of 77.9% and 83.4%), the unlifted fractions are also of high purity since they are a result of air classification (NDF of 42.5% and 68.8%) (Table 1). For this experimental work, the inventors assumed that fiber product would comprise the lifted as well as unlifted fractions from large and medium lighter fractions, along with the lifted fraction from small size lighter fraction. In scenarios where the quality of fiber is critical to fiber price, the unlifted fractions from electrostatic fractionation or separation of large and medium size lighter fractions would not be included as a part of the fiber product. When unlifted fractions from electrostatic fractionation or separation of large and medium size lighter fractions are not a part of the fiber product, the NDF of the fiber product would be about 74.0%.

When the electrostatic separation methodology of the present invention was used in conjunction with Elusieve processing, fiber product had a higher NDF (52.9%) compared to using Elusieve processing by itself (NDF of 40.5%). Higher quantity of enhanced flour (95.0% yield) was produced when the electrostatic method was used in conjunction with Elusieve processing compared to using Elusieve processing by itself (93.0% yield) without any change in quality of enhanced flour (an NDF of 6.6% in both cases) (Table 2). Thus, the novel electrostatic methodology improved fiber separation effectiveness when used in conjunction with Elusieve processing.

For designing a system that effectively separates fiber from corn flour, the effect of various parameters such as particle size, particle surface area, biochemical composition, and moisture content of fiber and nonfiber particles, for example, needs to be considered. The experimental work that resulted in the present invention provided an insight into the behavior of fiber and nonfiber particles under an electrostatic field, which can be exploited for better separation. Other size reduction methods such as roller milling and cryogenic grinding could result in better separation. An electrostatic direct current (DC) generating system with accurate voltage regulation over a wider range could also improve fiber separation.

### Variations and Other Embodiments of the Present Invention

A number of variations and alternate embodiments are possible to improve the effectiveness of fiber separation and overall efficient working of the system, method, and apparatus of the present invention.

The electrostatic separation methods, system, and apparatus of the invention can be achieved using a number of different arrangements. These variations can be in terms of sources for generating and controlling the electrical voltage(s); amount(s) of voltages and currents; numbers, shapes, and sizes of the electrodes, charged surface(s), and separation devices and materials; number of electrostatic units used in a unit; mechanisms of conveying and handling the material; separation of material streams into fiber and nonfiber, etc., all of which may improve the functioning of the final product and efficiency of the particle and material separations.

In addition to the fiber separation from corn flour and DDGS, the same fiber separation methodologies, using electrostatic fields and energy, from other grains such as barley flour, sorghum flour, and wheat flour, among others, is applicable. Various methods of converting grain to flour (hammer milling and roller milling, for example), various grain varieties, and moisture levels of the material being processed are applicable and can be analyzed for optimum effective working of the system, methods, and apparatus of the invention. Additionally, various conditions of incoming grain material such as whole flour, flour fractionated into different sizes, flours with previously-elevated levels of fiber by sieving and air classification, and the like can be optimized for best results.

### CONCLUSIONS

Lifted fractions in the electrostatic methods of the present invention had higher fiber content than corresponding unlifted fractions and the starting material, which showed that fiber was preferentially attracted by the electrostatically-charged surface material or plate. Thus, the electrostatic method was successfully used in lab scale to separate fiber from ground corn flour. The electrostatic method alone was not as effective as the Elusieve process alone when applied directly on original corn flour. The effectiveness of the electrostatic methodology was comparable with the Elusieve process when applied on sieved fractions of corn flour. The operational and capital costs would be determining factors in choosing between electrostatic fractionation and air classification, after the sieving step, at least for corn flour. The electrostatic methods of the invention improved fiber separation effectiveness when used in conjunction with Elusieve processing. Higher quantity of enhanced flour (95.0% yield) was produced when the electrostatic separation methodology was used in conjunction with Elusieve processing compared to using Elusieve processing by itself (93.0% yield) without any change in the quality of enhanced flour (an NDF of 6.6% in both cases).

The above detailed description is presented to enable any person skilled in the art to make and use the invention. Specific details have been revealed to provide a comprehensive understanding of the present invention, and are used for explanation of the information provided. These specific details, however, are not required to practice the invention, as is apparent to one skilled in the art. Descriptions of specific applications, analyses, and calculations are meant to serve only as representative examples. Various modifications to the preferred embodiments may be readily apparent to one skilled in the art, and the general principles defined herein may be applicable to other embodiments and applications while still remaining within the scope of the invention. There is no intention for the present invention to be limited to the embodiments shown and the invention is to be accorded the widest possible scope consistent with the principles and features disclosed herein.

While various embodiments of the present invention have been described above, it should be understood that they have been presented by way of example and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments.

The apparatus, processes, methods, materials, and system of the present invention are often best practiced by empirically determining the appropriate values of the operating parameters, or by conducting simulations to arrive at best design for a given application. Accordingly, all suitable modifications, combinations, and equivalents should be considered as falling within the spirit and scope of the invention.

TABLE 1
Yield % and compositions of fractions
from processing of corn flour

| Material | % Yield | Moisture % | % NDF (db) |
|---|---|---|---|
| Original | 100.0 | 11.7 | 8.9 |
| Original - Lifted- 13 μA | 3.1 | 11.7 | 18.1 |
| Original - Unlifted -13 μA | 96.9 | 11.4 | 7.5 |
| Original - Lifted - 16 μA | 3.9 | 12.0 | 10.4 |
| Original - Unlifted -16 μA | 96.1 | 11.7 | 8.2 |
| Sieved Fractions | | | |
| Large | 44.1 | 12.1 | 6.9 |
| Large- Lifted 16 μA | 4.1 | 11.0 | 62.4 |
| Large - Unlifted 16 μA | 95.9 | 12.0 | 5.4 |
| Large - Lifted 18 μA | 7.6 | 11.9 | 48.9 |
| Large - Unlifted 18 μA | 92.4 | 14.1 | 4.6 |
| Large - Lifted 20 μA | 8.7 | 11.6 | 42.8 |
| Large - Unlifted 20 μA | 91.3 | 11.8 | 5.3 |
| Medium | 22.6 | 11.1 | 11.3 |
| Medium - Lifted 14 μA | 4.2 | 11.8 | 64.8 |
| Medium - Unlifted 14 μA | 95.8 | 11.8 | 8.1 |
| Medium - Lifted 16 μA | 7.3 | 11.9 | 50.6 |
| Medium - Unlifted 16 μA | 92.7 | 12.0 | 6.8 |
| Medium - Lifted 20 μA | 10.5 | 11.5 | 41.7 |
| Medium - Unlifted 20 μA | 89.5 | 15.7 | 5.8 |
| Small | 12.5 | 11.6 | 10.3 |
| Small - Lifted 13 μA | 3.9 | 11.7 | 28.1 |
| Small - Unlifted 13 μA | 96.1 | 11.9 | 8.8 |
| Small - Lifted 16 μA | 4.7 | 11.8 | 19.9 |
| Small - Unlifted 16 μA | 95.3 | 11.8 | 9.0 |
| Small - Lifted 19 μA | 9.1 | 11.9 | 16.6 |
| Small - Unlifted 19 μA | 90.9 | 19.8 | 9.6 |
| Pan | 20.8 | 11.1 | 8.6 |
| Air Classification fractions | | | |
| Large - LF | 4.7 | 12.0 | 64.0 |
| Large - HF | 95.3 | 11.2 | ND |
| LF Large - Lifted 15 μA | 11.8 | 11.7 | 84.3 |
| LF Large - Unlifted 15 μA | 88.2 | 11.3 | 68.8 |
| LF Large - Lifted 18 μA | 10.0 | 11.8 | 81.3 |
| LF Large - Unlifted 18 μA | 90.0 | 11.6 | 65.5 |
| Medium - LF | 12.2 | 11.7 | 46.2 |
| Medium - HF | 87.8 | 11.7 | 4.5 |
| LF Medium - Lifted 15 μA | 9.6 | 11.6 | 77.9 |
| LF Medium - Unlifted 15 μA | 90.4 | 12.0 | 42.5 |
| LF Medium - Lifted 18 μA* | 10.2 | 11.8 | 73.3 |
| LF Medium - Unlifted 18 μA* | 89.8 | 12.0 | 42.5 |
| Small - LF | 16.0 | 12.0 | 22.1 |
| Small - HF | 84.0 | 11.7 | 6.2 |
| LF Small - Lifted 16 μA* | 11.4 | 12.0 | 63.7 |
| LF Small - Unlifted 16 μA* | 88.6 | 12.1 | 18.0 |
| LF Small - Lifted 20 μA* | 14.7 | 12.0 | 52.8 |
| LF Small- Unlifted 20 μA* | 85.3 | 11.8 | 14.3 |

Values are means of three batches; NDF—neutral detergent fiber; ND—not determined; LF—lighter fraction; HF—heavier fraction; Coefficients of variation (COV) for NDF and moisture were less than 21% and 16%, respectively.
*Values are means of two batches.

TABLE 2
Compositions (% wb) and wt % of corn flour and products
from electrostatic fractionation of original milled
corn, electrostatic fractionation of sieved corn flour
fractions, Elusieve processing and electrostatic fractionation
of Elusieved corn flour fractions

| | | Wt % of | |
|---|---|---|---|
| Processing method | Product | original flour | % NDF |
| None | Original Corn | 100.0 | 8.9 |
| | Flour | | |
| Electrostatic fractionation of | Fiber | 3.1 | 16.5 |
| original corn flour | En Flour | 96.9 | 8.7 |
| Electrostatic fractionation of | Fiber | 3.2 | 54.2 |
| Sieved Corn Flour | En Flour | 96.8 | 7.4 |
| Elusieve | Fiber | 6.8 | 40.5 |
| | En Flour | 93.2 | 6.6 |
| Electrostatic fractionation of | Fiber | 5.0 | 52.9 |
| Elusieve Lighter Fraction | En Flour | 95.0 | 6.6 |

En Flour—enhanced corn flour; NDF—neutral detergent fiber.

### REFERENCES

AACC International, 2000. Approved Methods of the AACC, 10th ed. The American Association of Cereal Chemists International, St Paul, Minn.
AOAC, 2003. Official methods of the AOAC, 17th ed. The Association of Official Analytical Chemists, Gaithersburg, Md.
Buhner, J., Agblevor, F. A., 2004. Effect of detoxification of dilute acid corn fiber hydrolysate on xylitol production. Appl. Biochem. Biotechnol. 119, pp. 13-30.
Crittenden, R. G., Playne, M. J., 1996. Production, properties and applications of food grade oligosaccharides. Trend Food Sci. Technol. 7, pp. 353-361.
Harmond, J. E., N. R. Brandenburg, and D. E. Booster, 1961. Agricultural Engineering. 42(1), pp. 22-25.
Hemery, Y., Xavier Rouau, Ciprian Dragan, Mihai Bilici, Radu Beleca, Lucian Dascalescu. 2009. Electrostatic properties of wheat bran and its constitutive layers: Influence of particle size, composition, and moisture content. Journal of Food Engineering. 93, pp. 114-124.
Matthes, R. K., Boyd, A. H., 1968. Electrical properties of seed associated with viability and vigor. ASAE Paper No. 68-807.
Moreau, R. A., Powell, M. J., Hicks, K. B., 1996. Extraction and quantitative analysis of oil from commercial corn fiber. J. Agric. Food Chem. 44, pp. 2149-2154.
Pandya, T. S., R. Srinivasan. 2012. Effect of hammermill retention screensize on fiber separation from corn flour using the Elusieve process. Ind Crops and Prod 35: pp. 37-43.
Srinivasan, R., Singh, V., 2008a. Pericarp fiber separation from corn flour using sieving and air classification. Cereal Chem. 85, pp. 27-30.
Srinivasan, R., and Corzo, A. 2011. Fiber Separation from Ground Corn Flour and its Effect on Nutritional Value of Poultry Diets. Trans ASABE. 54: pp. 543-548.
Van Soest, P. J., Robertson, J. B., Lewis, B. A., 1991. Methods for dietary fiber, neutral detergent fiber and non-starch polysaccharides in relation to animal nutrition. J. Dairy Sci. 74, pp. 3583-3597.

What is claimed is:

1. A method of obtaining a fiber-enriched grain material fraction and an enhanced fiber-reduced grain material fraction from starting grain material, the method comprising:
processing grain material for producing the starting grain material, wherein the processing is by drying, milling, or grinding, or a combination thereof;
separating the starting grain material into a fiber-enriched grain material fraction and an enhanced fiber-reduced grain material fraction by introducing an electrostatic field or charge to or across the starting grain material, wherein the fiber-enriched grain material fraction has a polarity charge and is attracted to an opposite polarity charge and thereby separated from the enhanced fiber-reduced grain material fraction;
separately collecting the fiber-enriched grain material fraction and the enhanced fiber-reduced grain material fraction; and
repeating the separating of the fiber-enriched grain material fraction using subsequent fiber-enriched grain material fraction and/or enhanced fiber-reduced grain material fraction and the separately collecting of additional fiber-enriched grain material fraction and enhanced fiber-reduced grain material fraction as many times as necessary to ensure effective separation;
wherein each respective separated material is enriched in fiber and reduced in fiber, respectively, relative to the starting grain material and to the immediately preceding separated fiber-enriched and fiber-reduced material fraction and wherein the enhanced fiber-reduced material fraction is enriched with increased starch, fat, protein, or a combination thereof, relative to the starting grain material and to the immediately preceding separated enhanced fiber-reduced material fraction.

2. The method of claim 1, wherein the electrostatic field or charge is generated by at least one direct current electrical source for electrostatically-charging at least one device or surface and is applied to the starting grain material and wherein the at least one device or surface has a charge opposite the charge of the fiber-enriched grain material fraction for attracting the fiber-enriched grain material fraction.

3. The method of claim 1, wherein the electrostatic field or charge is applied to the starting grain material and is generated by application of an external electric field without an electrostatically-charged device or surface, by mechanical contact to create an opposing and thereby attracting static electric field or charge between the fiber-enriched grain material fraction and another material, by contact between the fiber-enriched grain material fraction and a material disposed to creating a static electric field or charge therebetween, or a combination thereof.

4. The method of claim 1, wherein the starting grain material is grain, oilseed, grain product, oilseed product, corn, distillers dried grains (DDG), distillers dried grains with solubles (DDGS), sorghum, barley, soybean, cottonseed, oats, rice, rye, or a combination thereof.

5. The method of claim 2, wherein the electrostatically-charged device or surface has an externally-applied charge opposite in charge to the fiber-enriched grain material fraction for attracting the fiber-enriched grain material fraction and wherein the current externally applied is variable and controllable.

6. A method of obtaining a fiber-enriched grain material fraction and an enhanced fiber-reduced grain material fraction from starting grain material, the method comprising:
processing grain material for producing the starting grain material, wherein the processing is by drying, milling, or grinding, or a combination thereof;
separating the starting grain material by size into a first fiber-enriched grain material fraction and a first enhanced fiber-reduced grain material fraction, wherein the first fiber-enriched grain material fraction has a larger particle size and the first enhanced fiber-reduced grain material fraction has a smaller particle size;
collecting the first fiber-enriched grain material fraction and the first enhanced fiber-reduced grain material fraction;
separating the first fiber-enriched grain material fraction into a second fiber-enriched grain material fraction and a second enhanced fiber-reduced grain material fraction by introducing an electrostatic field or charge to or across the first fiber-enriched grain material fraction, wherein the second fiber-enriched grain material fraction has a polarity charge and is attracted to an opposite polarity charge and thereby separated from the second enhanced fiber-reduced grain material fraction;
separately collecting the second fiber-enriched grain material fraction and the second enhanced fiber-reduced grain material fraction;
repeating the size separation and electrostatic field or charge separation individually or in combination using subsequent fiber-enriched grain material fraction and/or enhanced fiber-reduced grain material fraction and the separately collecting of additional fiber-enriched grain material fraction and enhanced fiber-reduced grain material fraction as many times as necessary to ensure effective separation; and
separately combining the first and subsequent fiber-enriched grain material fraction and separately combining the first and subsequent enhanced fiber-reduced grain material fraction;
wherein each respective separated material is enriched in fiber and reduced in fiber, respectively, relative to the starting grain material and to the immediately preceding separated fiber-enriched and enhanced fiber-reduced material fraction and wherein the enhanced fiber-reduced material fraction is enriched with increased starch, fat, protein, or a combination thereof, relative to the starting grain material and to the immediately preceding separated enhanced fiber-reduced material fraction.

7. The method of claim 6, wherein completion of the size separation and electrostatic field or charge separation is in any order in time such that the fiber-enriched grain material fraction is separated from the enhanced fiber-reduced grain material fraction.

8. The method of claim 6, wherein the electrostatic field or charge is generated by at least one direct current electrical source for electrostatically-charging at least one device or surface and is applied to the first fiber-enriched grain material fraction and wherein the at least one device or surface has a charge opposite the charge of the second fiber-enriched grain material fraction for attracting the second fiber-enriched grain material fraction.

9. The method of claim 6, wherein the electrostatic field or charge is applied to the first fiber-enriched grain material fraction and is generated by application of an external electric field without an electrostatically-charged device or surface, by mechanical contact to create an opposing and thereby attracting static electric field or charge between the second fiber-enriched grain material fraction and another material, by contact between the first fiber-enriched grain material fraction and a material disposed to creating a static electric field or charge therebetween, or a combination thereof.

10. The method of claim 6, wherein the starting grain material is grain, oilseed, grain product, oilseed product, corn, distillers dried grains (DDG), distillers dried grains with solubles (DDGS), sorghum, barley, soybean, cottonseed, oats, rice, rye, or a combination thereof.

11. The method of claim 8, wherein the electrostatically-charged device or surface has an externally-applied charge opposite in charge to the fiber-enriched grain material fraction for attracting the fiber-enriched grain material fraction and wherein the current externally applied is variable and controllable.

12. A method of obtaining a fiber-enriched grain material fraction and an enhanced fiber-reduced grain material fraction from starting grain material, the method comprising:
processing grain material for producing the starting grain material, wherein the processing is by drying, milling, or grinding, or a combination thereof;
separating the starting grain material by particle size, shape, weight, density, or a combination thereof, by air classifying the starting grain material into a first fiber-enriched grain material fraction and a first enhanced fiber-reduced grain material fraction, wherein the first fiber-enriched grain material fraction is a lighter material enriched in fiber and the first enhanced fiber-reduced grain material fraction is a heavier material reduced in fiber;
collecting the first fiber-enriched grain material fraction and the first enhanced fiber-reduced grain material fraction;
separating the first fiber-enriched grain material fraction into a second fiber-enriched grain material fraction and a second enhanced fiber-reduced grain material fraction by introducing an electrostatic field or charge to or across the first fiber-enriched grain material fraction, wherein the second fiber-enriched grain material fraction has a polarity charge and is attracted to an opposite polarity charge and thereby separated from the second enhanced fiber-reduced grain material fraction;
separately collecting the second fiber-enriched grain material fraction and the second enhanced fiber-reduced grain material fraction;
repeating the air classification and electrostatic field or charge separation individually or in combination using subsequent fiber-enriched grain material fraction and/or enhanced fiber-reduced grain material fraction and the separately collecting of additional fiber-enriched grain material fraction and enhanced fiber-reduced grain material fraction as many times as necessary to ensure effective separation; and
separately combining the first and subsequent fiber-enriched grain material fraction and separately combining the first and subsequent enhanced fiber-reduced grain material fraction;
wherein each respective separated material is enriched in fiber and reduced in fiber, respectively, relative to the starting grain material and to the immediately preceding separated fiber-enriched and enhanced fiber-reduced material fraction and wherein the enhanced fiber-reduced material fraction is enriched with increased starch, fat, protein, or a combination thereof, relative to the starting grain material and to the immediately preceding separated enhanced fiber-reduced material fraction.

13. The method of claim 12, wherein completion of the air classification and electrostatic field or charge separation is in any order in time such that the fiber-enriched grain material fraction is separated from the enhanced fiber-reduced grain material fraction.

14. The method of claim 12, wherein the electrostatic field or charge is generated by at least one direct current electrical source for electrostatically-charging at least one device or surface and is applied to the first fiber-enriched grain material fraction and wherein the at least one device or surface has a charge opposite the charge of the second fiber-enriched grain material fraction for attracting the second fiber-enriched grain material fraction.

15. The method of claim 12, wherein the electrostatic field or charge is applied to the first fiber-enriched grain material fraction and is generated by application of an external electric field without an electrostatically-charged device or surface, by mechanical contact to create an opposing and thereby attracting static electric field or charge between the second fiber-enriched grain material fraction and another material, by contact between the first fiber-enriched grain material fraction and a material disposed to creating a static electric field or charge therebetween, or a combination thereof.

16. The method of claim 12, wherein the starting grain material is grain, oilseed, grain product, oilseed product, corn, distillers dried grains (DDG), distillers dried grains with solubles (DDGS), sorghum, barley, soybean, cottonseed, oats, rice, rye, or a combination thereof.

17. The method of claim 14, wherein the electrostatically-charged device or surface has an externally-applied charge opposite in charge to the fiber-enriched grain material fraction for attracting the fiber-enriched grain material fraction and wherein the current externally applied is variable and controllable.

18. A method of obtaining a fiber-enriched grain material fraction and an enhanced fiber-reduced grain material fraction from starting grain material, the method comprising:
processing grain material for producing the starting grain material, wherein the processing is by drying, milling, or grinding, or a combination thereof;
separating the starting grain material by size into a first fiber-enriched grain material fraction) and a first enhanced fiber-reduced grain material fraction, wherein the first fiber-enriched grain material fraction has a larger particle size and the first enhanced fiber-reduced grain material fraction has a smaller particle size;
collecting the first fiber-enriched grain material fraction and the first enhanced fiber-reduced grain material fraction;
air classifying the first fiber-enriched grain material fraction into a second fiber-enriched grain material fraction and a second enhanced fiber-reduced grain material fraction based on particle size, shape, weight, density, or a combination thereof, wherein the second fiber-enriched grain material fraction is a lighter material enriched in fiber relative to the first fiber-enriched grain material fraction and the second enhanced fiber-reduced grain material fraction is a heavier material reduced in fiber relative to the first enhanced fiber-reduced grain material fraction;
collecting the second fiber-enriched grain material fraction and the second enhanced fiber-reduced grain material fraction;
separating the second fiber-enriched grain material fraction into a third fiber-enriched grain material fraction and a third enhanced fiber-reduced grain material fraction by introducing an electrostatic field or charge to or across the second fiber-enriched grain material fraction, wherein the third fiber-enriched grain material fraction has a polarity charge and is attracted to an opposite polarity charge and thereby separated from the third enhanced fiber-reduced grain material fraction;
separately collecting the third fiber-enriched grain material fraction and the third enhanced fiber-reduced grain material fraction;
repeating the size separation, air classification, and electrostatic field or charge separation individually or in combination using subsequent fiber-enriched grain material fraction and/or enhanced fiber-reduced grain material fraction and the separately collecting of additional fiber-enriched grain material fraction and enhanced fiber-reduced grain material fraction as many times as necessary to ensure effective separation; and
separately combining the first and subsequent fiber-enriched grain material fraction and separately combining the first and subsequent enhanced fiber-reduced grain material fraction;
wherein each respective separated material is enriched in fiber and reduced in fiber, respectively, relative to the starting grain material and to the immediately preceding separated fiber-enriched and enhanced fiber-reduced material fraction and wherein the enhanced fiber-reduced material fraction is enriched with increased starch, fat, protein, or a combination thereof, relative to the starting grain material and to the immediately preceding separated enhanced fiber-reduced material fraction.

19. The method of claim 18, wherein completion of the size separation, air classification, and electrostatic field or charge separation is in any order in time such that the fiber-enriched grain material fraction is separated from the enhanced fiber-reduced grain material fraction.

20. The method of claim 18, wherein the electrostatic field or charge is generated by at least one direct current electrical source for electrostatically-charging at least one device or surface and is applied to the second fiber-enriched grain material fraction and wherein the at least one device or surface has a charge opposite the charge of the third fiber-enriched grain material fraction for attracting the third fiber-enriched grain material fraction.

21. The method of claim 18, wherein the electrostatic field or charge is applied to the second fiber-enriched grain material fraction and is generated by application of an external electric field without an electrostatically-charged device or surface, by mechanical contact to create an opposing and thereby attracting static electric field or charge between the third fiber-enriched grain material fraction and another material, by contact between the second fiber-enriched grain material fraction and a material disposed to creating a static electric field or charge therebetween, or a combination thereof.

22. The method of claim 18, wherein the starting grain material is grain, oilseed, grain product, oilseed product, corn, distillers dried grains (DDG), distillers dried grains with solubles (DDGS), sorghum, barley, soybean, cottonseed, oats, rice, rye, or a combination thereof.

23. The method of claim 20, wherein the electrostatically-charged device or surface has an externally-applied charge opposite in charge to the fiber-enriched grain material fraction for attracting the fiber-enriched grain material fraction and wherein the current externally applied is variable and controllable.
